(19) United States
(12) Patent Application Publication
(10) Pub. No.: US 2014/0259376 A1
(43) Pub. Date: Sep. 18, 2014

(54) LIGHTING SYSTEM FOR A SINK AND LIGHTED SINK KIT

(71) Applicant: Glowsink, LLC, Sanford, FL (US)

(72) Inventor: Jason S. Turner, Sanford, FL (US)

(73) Assignee: Glowsink, LLC, Sanford, FL (US)

(21) Appl. No.: 14/083,314

(22) Filed: Mar. 14, 2014

Related U.S. Application Data
(60) Provisional application No. 61/787,549, filed on Mar. 15, 2013.

(51) Int. Cl. F21V 33/00; E03C 1/18

(52) U.S. Cl. CPC F21V 33/004; E03C 1/18
USPC 4/638; 362/234

(57) ABSTRACT

A lighting system has a flexible member to engage a sink edge, lighting elements, and a controller to illuminate the sink. The sink is preferably glass or other transparent material with a non-smooth surface to reflect the light. The flexible member is optically transparent to allow the light to reach the sink. The sink may also have a motion detector to illuminate the sink upon approaching the sink. The lighting system and sink may be combined as a kit to be provided to homeowners.

### BACKGROUND OF THE INVENTION

1. Field of the Invention

The present invention relates generally to a system to illuminate a sink and, in particular, an automatically and controlled system to illuminate an undermounted glass sink.

2. Technical Background

There many ways to illuminate a bathroom. Night lights have been used for decades to illuminate bathrooms as well as other rooms in a house or building. There are also lights that have been adapted to illuminate the water out of the bathroom faucets. However, Applicant is unaware of any lighting of a sink or basin in the bathroom, other than to shine a light on it from the wall, ceiling, or faucet.

However, it would beneficial to be able to illuminate a sink to provide light to the bathroom and also function as a nightlight if the owner so desired.

### SUMMARY OF THE INVENTION

In one aspect, a lighting system for a sink includes a flexible member to engage at least a portion of the sink, a plurality of lighting elements attached to the flexible member; and a controller in electrical communication with the plurality of lighting elements.

In some embodiments, the flexible member is attached to a periphery of the sink and the sink is an undermount style sink and the flexible member seals the sink against a countertop.

In some embodiments, the plurality of lighting elements are LEDs.

In some embodiments, the lighting elements and the controller are in electrical communication through an electrical wire and the electrical wire has a connector for connection to another electrical wire associated with another sink.

In other embodiments, the lighted sink is illuminated when a sensor detects motion in front of the sink.

In other embodiments, the lighting elements are controlled by switches attached to the sink.

In yet another aspect, a lighted sink kit for a sink includes a sink having a peripheral edge and a non-smooth surface, a plurality of lighting elements, a flexible member to engage at least a portion of the sink, the flexible member having a plurality of receptacles for the plurality of lighting elements, and a controller in electrical communication with the plurality of lighting elements.

Additional features and advantages of the invention will be set forth in the detailed description which follows, and in part will be readily apparent to those skilled in the art from that description or recognized by practicing the invention as described herein, including the detailed description, which follows, the claims, as well as the appended drawings.

It is to be understood that both the foregoing general description and the following detailed description of the present embodiments of the invention are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and, together with the description, serve to explain the principles and operations of the invention.

### BRIEF DESCRIPTION OF THE DRAWINGS

FIG. 1 is a schematic illustration of one embodiment of a lighting system for a sink according to the present invention;

FIG. 2 is a cross section view of the sink, the flexible member and the lighting element in the lighting system for a sink of FIG. 1;

FIG. 3 is a cross section view of a portion of a sink, the flexible member and the lighting element in the lighting system for a sink of FIG. 1; and

FIG. 4 is a partial cross section showing the lighting system installed under a countertop with the flexible member and the lighting element installed;

FIG. 5 is a partial cross section of another embodiment of a sink to be used with the lighting system according to the present invention;

FIG. 6 is schematic illustration of another embodiment of a lighting system for a sink according to the present invention;

FIG. 7 a partial cross section showing the lighting system installed under a countertop with the flexible member and the lighting element installed; and

FIG. 8 is a partial front view of the sink of FIG. 6 illustrating switches to control the lighting system;

FIG. 9 is a partial cross section of another embodiment of a lighting system for a sink according to the present invention; and

FIG. 10 is a schematic illustrating the components of the lighting system for a sink of FIG. 9.

### DETAILED DESCRIPTION OF THE PREFERRED EMBODIMENTS

Reference will now be made in detail to the present preferred embodiment(s) of the invention, examples of which are illustrated in the accompanying drawings. Whenever possible, the same reference numerals will be used throughout the drawings to refer to the same or like parts.

Referring to FIGS. 1-3, one embodiment of lighting system 100 for a sink 102 is illustrated. The lighting system 100 includes a flexible member 104 that is preferably a unitary elastic member that encircles the edge 106 of the sink 102. See FIG. 2. The flexible member 104 is preferably a silicone ring that may have a u-shaped cross section as illustrated in FIG. 2. The flexible member 104 is preferably sized to fit the sink 102 to be used in the room; the larger the sink to be installed, the larger the flexible member 104 should be. The flexible member 104 also preferably functions as the seal between the sink 102 and the countertop 108 under which the sink 102 is mounted. See FIG. 3. Since the flexible member 104 is flexible and deformable, it is able to ensure a tight seal between the sink 102 and the countertop to prevent any water from getting under the sink 102.

The lighting system also has a plurality of lighting elements 110 that are spaced around the edge 106 of the sink 102 and the flexible member 104. See FIG. 2. While only one lighting element is shown, there are a plurality of lighting elements spaced around the flexible member. The number of the lighting elements 110 depends on the size of the flexible member 104, the size of the sink 102, and the amount of light wanted to illuminate the sink 102. The lighting elements 110 are preferably inserted into pockets 112 in the flexible member 104, but could be attached to the flexible member 104 in any appropriate manner, including adhesives, clips, tapes, through a friction fit, etc. The flexible member 104 is therefore optically transparent to allow the light emitted by the lighting elements to pass through the flexible member 104 to illuminate the sink 102. The lighting elements 110 are connected to one another by electrical wires 114. The electrical wires 114 also have a connector 116 to connect to a controller 130, described in more detail below. The electrical wires 114 may also have a second connector 118, which would allow two adjacent sinks 102 (second sink not illustrated) to be connected to one another and controlled by a single controller 130.

The lighting elements 110 are preferably light emitting diodes (LEDs), but could be any appropriate type of light emitting device.

The sink 102 is a preferably a glass sink, but may be of any material that allows light to be transmitted therethrough. This would include plastic, borosilicate, acrylic, or any other translucent materials. The sink 102 preferably has an outside surface 120 that is a non-smooth surface so as to reflect the light from the lighting elements 110 around and out of the sink 102. The present invention also contemplates that the sink 102′ may have elements 122 disposed between the surfaces (top and bottom) to reflect the light from the lighting elements 110. See FIG. 5. The elements 122 may be discontinuous surfaces, inserts incorporated into the sink 102, or other structures to reflect the light from the lighting elements 110.

The lighting elements 110 are controlled by a controller 130. The controller 130 can be plugged into an electrical outlet 132 under the cabinet (not shown) in which the sink 102 is installed. The controller 130 can be mounted above the countertop 108 to allow for easy access for the owner or operator. The controller 130 is preferably a touch screen device that can be programmed or have light controlling applications downloaded, e.g., an android-type or other programmable device. Also, a dedicated device could also be used as the controller 130. The controller 130 is responsible for turning the lighting elements 110 on and off, changing the color, the frequency with which the lights are turned on and off, or that the colors of the lighting elements are changed. The controller 130 may also control the intensity of the lighting elements 110, such that the lighting elements 110 could emit a low level of light and the lighting system 100 and the sink 102 could function as a night light.

Another embodiment of a lighting system 200 for a sink 202 is illustrated in FIGS. 6-8. The sink 202 is a preferably a glass sink, but may be of any material that allows light to be transmitted therethrough. This would include plastic, borosilicate, acrylic, or any other translucent materials. The sink 202 preferably has a outside surface 220 that is a non-smooth surface so as to reflect the light from lighting elements 210 around and out of the sink 202. Again, the sink 202 may also have elements between the surfaces of the sink 202 to reflect the light as discussed above. The lighting system 200 includes a flexible member 204 that is preferably a unitary elastic member that encircles the edge 206 of the sink 202. See FIG. 7. The flexible member 204 is preferably a silicone ring that may have a u-shaped cross section as illustrated in FIG. 7. The flexible member 204 is preferably sized to fit the sink 202 to be used; the larger the sink to be installed, the larger the flexible member 204 should be. The flexible member 204 also preferably functions as the seal between the sink 202 and the countertop 208 under which the sink 202 is mounted. See FIG. 7. Since the flexible member 204 is flexible and deformable, it is able to ensure a tight seal between the sink 202 and the countertop 208 to prevent any water from getting under or behind the sink 202.

The lighting system also has a plurality of lighting elements 210 that are spaced around the edge 206 of the sink 202 and the flexible member 204. See FIG. 7. While only one lighting element is shown, there are a plurality of lighting elements spaced around the flexible member 204. The number of the lighting elements 210 depends on the size of the flexible member 204 and the amount of light wanted to illuminate the sink 202. The lighting elements 210 are preferably inserted into pockets 212 in the flexible member 204, but could be attached to the flexible member 204 in any appropriate manner, including adhesives, clips, tapes, by friction fit, etc. The flexible member 204 is therefore optically transparent to allow the light emitted by the lighting elements to pass through the flexible member 204 to illuminate the sink 202. Similarly, the flexible member 204 may only have optically transparent portions adjacent the lighting elements 210 or simply openings with the lighting elements 210 being sealed against water. The lighting elements 210 are connected to one another by electrical wires 214. The electrical wires 214 also have a connector 216 to connect to a controller 230, described in more detail below. The electrical wires 214 may also have a second connector 218, which would allow two adjacent sinks 202 to be connected to one another and controlled by a single controller 230.

The lighting elements 210 are controlled by the controller 230. The controller 230 is preferably plugged into an electrical outlet 232 under the cabinet (not shown) in which the sink 202 is installed. The controller 230 is preferably mounted on or even in the sink 202. The controller 230 can be mounted on the outer surface 220 of the sink 202 under the countertop 208 to protect the controller 230 from contact, water, and tampering. To provide even more protection, the controller 230 may even be encapsulated within the sink 202. At least one switch 234, and more preferably several switches 234, are provided on an inside surface 224 of the sink 202 to send signals to the controller 230. As illustrated, the switches 234 are preferably disposed next to the flexible member 204 at the top of the sink, just under the countertop 208. This position protects the switches 234 from being hit, tampering, and potential abuse, particularly if the system 200 is used in a more commercial or public space. The switches 234 can be any type of switch, including, for example, copper leaf, push button, infrared proximity switches, etc. They may be contact or non-contact switches. The switches 234 can be used to change the frequency of light changes, the colors, the brightness, etc. In this regard, the lighting system 200 could be used as a night light if programmed in this manner.

The controller 230 may have an access point (such as rotary switches, USB port, etc.) to allow a service person or owner to program or reprogram the controller 230. Rather than have the controller mounted on the wall as above, the controller 230 is controlled by the switches 234.

The lighting system 200 also include a detector 240. The detector 240 is preferably disposed on an inside surface 224 of the sink 202, and most preferably under where the spout and/or handles for the sink 202 are located. This position allows the detector 240 to be able to detect the presence of a person who wants to use the sink 202 as the person approaches. The sensitivity of the detector 240 can be programmed, either directly or through the controller 230. The detector 240 may be of any appropriate type: infrared, PIR, proximity, motion, etc.

Another embodiment of a lighting system 300 for a sink 302 is illustrated in FIGS. 9-10. The sink 302 is a preferably a glass sink, but may be of any material that allows light to be transmitted therethrough. This would include plastic, borosilicate, acrylic, or any other translucent materials. The sink 302 preferably has a outside surface 320 that is a non-smooth surface so as to reflect the light from lighting elements 310 around and out of the sink 302. Again, the sink 302 may also have elements between the surfaces of the sink 302 to reflect the light as discussed above. The lighting system 300 includes a flexible member 304 that is preferably a unitary elastic member that encircles the edge 306 of the sink 302. See FIG. 7. The flexible member 304 is preferably a silicone ring that may have a u-shaped cross section as illustrated in FIG. 3. The flexible member 304 is preferably sized to fit the sink 302 to be used; the larger the sink to be installed, the larger the flexible member 304 should be. The flexible member 304 also preferably functions as the seal between the sink 302 and the countertop 308 under which the sink 302 is mounted. Since the flexible member 304 is flexible and deformable, it is able to ensure a tight seal between the sink 302 and the countertop 308 to prevent any water from getting under or behind the sink 302.

The lighting system also has a plurality of lighting elements 310 that are spaced around the edge 306 of the sink 302 and the flexible member 304. The lighting elements 310 are preferably LEDs but could be other types of lighting elements (incandescent) and still fall within the scope of the present invention. While only one lighting element is shown, there are a plurality of lighting elements spaced around the flexible member 304. The number of the lighting elements 310 depends on the size of the flexible member 304 and the amount of light wanted to illuminate the sink 302. The lighting elements 310 are preferably inserted into pockets in the flexible member 304, but could be attached to the flexible member 304 in any appropriate manner, including adhesives, clips, tapes, by friction fit, etc. The flexible member 304 is therefore optically transparent to allow the light emitted by the lighting elements 310 to pass through the flexible member 304 to illuminate the sink 302. Similarly, the flexible member 304 may only have optically transparent portions adjacent the lighting elements 310 or simply openings with the lighting elements 310 being sealed against water from the sink 302. The lighting elements 310 are connected to one another as is typical. The lighting elements 310 are connected to a controller 330, described in more detail below.

The controller 330 is illustrated in FIG. 10 and is electrically connected to the lighting elements 310 through first and second touch input modules 332,334 respectively. The first and second touch input modules 332,334 are in turn connected to first and second sensors 336,338, respectively. The first and second sensors 336,338 are preferably mounted on opposite sides of the sink 302, but could be mounted anywhere around the sink 302. The first and second sensors 336,338 detect the presence of an object (i.e., a hand or arm or other object) in the sink 302 in the proximity of the first and second sensors 336,338. The first and second sensors 336,338 detect the object through capacitive, inductive, or optical means.

The controller 330 also has a power supply 340, which is illustrated as a 12V universal power supply. The controller 330 also has a USB connection point 342 to allow for access, programming and control of the controller 330. A bluetooth module 344 is also provided on the controller 330 to allow for access, programming and control of the controller 330 without having to directly connect to the controller 330.

The lighting elements 310 are controlled by controller 330 through the switches 350, which allow for fine control of the lighting elements 310. The switches 350 include a play/pause switch 352 that can play a preprogrammed light show, which may include the changing of colors, intensity of the light, which lighting elements 310 are illuminated and in what colors and for a specific time period, etc. The controller 330 also includes a mode switch 354 that provides a particular mode for the illumination of the lighting elements 310. These modes include, for example, continuous illumination, pulsing of light, etc. as is known with lighting elements.

The controller 330 also includes an override switch 356 that allows an operator to access the controller 330 and to override any programs that are running to control the lighting elements 310 or the lighting system 300. The controller 330 also includes intensity switches 358,360, which are to increase and decrease, respectively, the intensity of the light being emitted from lighting elements 310.

A solid color switch 362 is also included on the controller 330. The solid color switch 362 allows a user to change the lighting elements 310 to have the LEDs emit only a single color. The user can press the switch 362 until the wanted color is emitted.

The controller 330 also has drivers 364 to illuminate the particular lighting elements 310. As illustrated, a number of drivers 364 are included to drive red, blue, green, white, and UV lighting elements 310. However, the controller 330 may also have drivers for a smaller or larger number of lighting elements 310 or LEDs. Additionally, the lighting elements 310 may be different than those illustrated. For example, a black light may be one of the lighting elements and need an appropriate driver. The UV lighting elements 310 may be used to deter or killing bacteria that may try to grow in the sink 302.

The controller 330 also has a driver for a blue LED that can be used to illuminate a logo that is incorporated into the sink 302. Again, a different number or colors of LEDs/lighting elements can be used and fall within the scope of the present invention.

The lighting systems 100,200,300 and the sinks 102,202,302 could also be packaged as a kit for homeowners to install themselves.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

I claim:

1. A lighting system for a sink comprising:
a flexible member to engage at least a portion of the sink;
a plurality of lighting elements attached to the flexible member; and
a controller in electrical communication with the plurality of lighting elements.

2. The lighting system for a sink according to claim 1, wherein the flexible member is optically transparent.

3. The lighting system for a sink according to claim 1, wherein flexible member engages a glass sink.

4. The lighting system for a sink according to claim 1, wherein the flexible member is attached to at least a portion of an edge of the sink.

5. The lighting system for a sink according to claim 1, wherein the flexible member is attached to a periphery of the sink, the sink is an undermount style sink, and the flexible member seals the sink against a countertop.

6. The lighting system for a sink according to claim 1, wherein the plurality of lighting elements are LEDs.

7. The lighting system for a sink according to claim 1, wherein the lighting elements and the controller are in electrical communication through an electrical wire.

8. The lighting system for a sink according to claim 7, wherein the electrical wire has a connector for connection to another electrical wire associated with another sink.

9. The lighting system for a sink according to claim 1, further comprising at least one sensor to detect motion in the sink, the sensor sending a signal to the controller in response thereto.

10. The lighting system for a sink according to claim 1, wherein the controller controls the emission of light from the plurality of lighting elements

11. The lighting system for a sink according to claim 1, further comprising at least one switch in electrical communication with the controller and the lighting elements attached to an interior surface of the sink.

12. A lighted sink kit comprising:
a sink having a peripheral edge and a non-smooth surface;
a plurality of lighting elements;
a flexible member to engage at least a portion of the sink, the flexible member having a plurality of receptacles for the plurality of lighting elements; and
a controller in electrical communication with the plurality of lighting elements.

13. The lighted sink kit according to claim 12, wherein the plurality of lighting elements are LEDs.

14. The lighted sink kit according to claim 12, wherein the non-smooth surface is at least a portion of an outside surface of the sink.

15. The lighted sink kit according to claim 12, wherein the flexible member is attached to the peripheral edge of the sink, the sink is an undermount style sink, and the flexible member seals the sink against a countertop.

16. The lighted sink kit according to claim 12, wherein the lighting elements and the controller are in electrical communication through an electrical wire.

17. The lighted sink kit according to claim 16, wherein the electrical wire has a connector for connection to another electrical wire associated with another sink.

18. The lighted sink kit according to claim 16, wherein the controller is attached to an outer surface of the sink.

19. The lighted sink kit according to claim 16, further comprising a sensor to detect motion in the sink, the sensor sending a signal to the controller in response thereto.
